(19) United States
(12) Patent Application Publication
(10) Pub. No.: US 2026/0371002 A1
(43) Pub. Date: Nov. 19, 2026

(54) DRIVER ASSEMBLY

(71) Applicant: EXIGY LIMITED, Buckinghamshire (GB)

(72) Inventor: Matthew James DOBSON, High Wycombe (GB)

(21) Appl. No.: 19/676,549

(22) Filed: May 13, 2026

(30) Foreign Application Priority Data
May 14, 2025 (GB) 2507467.5

(51) Int. Cl. H04R 1/28; H04R 1/24; H04R 1/32

(52) U.S. Cl. CPC H04R 1/288; H04R 1/24; H04R 1/323

(57) ABSTRACT

A driver assembly for use in a multiple-driver loudspeaker for converting electrical signals into acoustic sound includes a first driver having a first flange; a second driver having a second flange; and a damping manifold having a first mounting slot arranged to retain the first flange, a second mounting slot arranged to retain the second flange, and a first port. When the first and second flanges are received into the respective mounting slots, the first and second drivers are arranged facing each other on a common central driver axis bisected by a driver midpoint lying between the first and second drivers. The first port is arranged such that, in use, sound is directed out of the damping manifold through the first port in a direction substantially perpendicular to the common central driver axis. The damping manifold comprises a resiliently deformable material selected to provide resonance damping, in use.

### FIELD OF INVENTION

The invention relates to a driver assembly for converting electrical signals into acoustic sound.

### Background to the Invention

A single loudspeaker driver mounted in a cabinet works by moving a cone in and out, so creating vibrations of the air in contact with the cone, which then propagate through the air as sound. In a typical loudspeaker, the driver is mounted in a cabinet to contain the reverse polarity output from the back, preventing it from interfering with output from the front.

The force moving the cone is created by a coil/magnet assembly (the motor) which always has an equal and opposite reactive force being applied at the motor. The motor reactive force is constrained by the mechanical fixing of the motor to the cabinet via the loudspeaker driver frame (commonly referred to as a driver ‘basket’). This reactive energy is dissipated in several ways, the most obvious are: slight flexing of the cabinet face the driver is fixed to, slight movement of the entire cabinet, exciting resonances of cabinet and driver parts. The energy is dissipated as sound (unwanted, usually in opposition and as a distortion to the wanted sound) and heat. The vibration-to-heat mechanism is friction (damping) in the driver frame, the cabinet material and between the cabinet and what it sits on via flexible feet or spikes passing energy into a supporting structure, where it is dissipated as more vibration and/or heat, within a less movable object. In general, such energy goes un-noticed and in typical loudspeaker designs this energy dissipation is accepted as normal functionality. The wanted sound energy is much larger than the un-wanted, and so typically masks the un-wanted sufficiently that it is not noticed. It is generally not much of an issue if the driver and cabinet heat up a little, and most users tend not to notice any cabinet vibration unless it causes secondary vibration of surfaces in the room. However, this energy dissipation is a distortion; it can be measured and cabinet vibrations (especially reaction to heavy cones at low frequency) will, to some extent, modulate the output of other drivers mounted in the same cabinet, by vibrating their fixing points. Efforts to minimize and/or mitigate this unwanted energy dissipation have been an ongoing area of interest for many years, with the aim of providing an improved quality of loudspeaker that has fewer distortions.

It is known that mounting two identical loudspeaker chassis opposite each other on either side of a cabinet creates an apparent force-cancelling arrangement where the reactive forces on the driver frames created by accelerating the two loudspeaker cones in opposite directions, are mostly cancelled out. In such arrangements the aim is for the air to move, not the cabinet or driver frames. However, while the overall cabinet vibration is generally almost completely cancelled in such an arrangement, other vibrations remain and may increase to compensate as forces must always balance. If overall cabinet vibration is cancelled, it is known that vibration of the mounting panels will tend to increase. Such vibration may be reduced or eliminated buy cross coupling between the driver mounting points with solid bars. However, the energy remains, and it has been found that such rigid coupling of two opposed drivers can considerably intensify the natural resonance of the driver basket/motor combination (the basket being the spring, the motor being the sprung mass) and all attached parts. Such unwanted resonance can cause distortions and poor performance of the loudspeaker.

There exists, therefore, a need to provide an improved method of reducing unwanted energy dissipation and resonances in loudspeakers. As outlined in more detail below, the present disclosure provides an inventive solution to this problem.

### SUMMARY OF THE INVENTION

According to a first aspect of the disclosure, there is provided a driver assembly for use in a multiple-driver loudspeaker for converting electrical signals into acoustic sound, the driver assembly comprising: a first driver having a first flange; a second driver having a second flange; and a damping manifold having a first mounting slot arranged to retain the first flange, and a second mounting slot arranged to retain the second flange, and a first port; wherein when the first and second flanges are received into the respective mounting slots, the first and second drivers are arranged facing each other on a common central driver axis bisected by a driver midpoint lying between the first and second drivers; wherein the first port is arranged such that, in use, sound is directed out of the damping manifold through the first port in a direction substantially perpendicular to the common central driver axis; and wherein the damping manifold comprises a resiliently deformable material selected to provide resonance damping, in use.

As discussed above, existing multi-driver loudspeaker designs that attempt to achieve force-cancellation typically involve a single cabinet with equally powered drivers mounted on opposite faces, both wired to simultaneously move cones either into or out of the cabinet, in phase. An alternative known arrangement is with two drivers each mounted in identical but separate cabinets and bolted together at the driver mounting points, creating a force cancelling arrangement, the drivers firing into the 360-degree space or slot between the cabinets. As discussed above, each of these arrangements can result in unexpected resonances and distortions being produced in use.

The driver assemblies according to the present disclosure provide an improved force-cancellation approach in which opposed drivers fire into a space that is substantially enclosed within a damping manifold, but with a port through which sound produced by the drivers can exit. The space is enclosed by the damping manifold, with a single port through which sound can exit. The damping manifold comprises a resiliently deformable material (such as a moulded elastomer) with mounting slots that are arranged to receive and retain the driver flanges. By comprising a resiliently deformable material, the damping manifold allows for the manifold to accurately locate both drivers, typically without the need for any additional fasteners. This is advantageous as it allows for the drivers to be easily and precisely positioned during assembly, while preventing resonance or distortions that may be caused by such additional fasteners. The damping manifold also seals each of the drivers on both sides, thereby improving the performance of the drivers.

By being resiliently deformable, the damping manifold also provides a degree of resilience to absorb the reactive energy while suppressing resonances. This is advantageous as it improves the performance of the driver assembly, allowing for force-cancellation while preventing unwanted resonances and distortions that are present in the alternative arrangements discussed above.

By comprising a single port, the damping manifold provides a seamless exit which may be shaped for best output dispersion while preventing reflective surfaces introducing any problematic reflections from other radiators within the loudspeaker system.

In an embodiment, there is provided a driver assembly further comprising a housing having a first back chamber, a second back chamber, and a central chamber disposed between the first and second back chambers, the central chamber being configured to receive and retain the damping manifold. The housing provides structural support for the driver assembly, while also providing separate spaces for the front and rear of the drivers. The two back chambers are each configured to receive the rear of one of the drivers, with the central chamber being configured to receive the fronts of the drivers. This allows for the front and rear of the drivers to be acoustically isolated from one another, thereby improving the acoustic performance of the drivers and the driver assembly.

In an embodiment, there is provided a driver assembly wherein the damping manifold is arranged to provide a seal between the first back chamber and the central chamber, and a seal between the first back chamber and the central chamber. Providing a seal between the back chambers and the central chamber, the acoustic performance of the drivers is improved. The damping manifold providing this seal is particularly advantageous, as it simplifies the design of the driver assembly thereby improving performance while reducing the number of components needed.

In an embodiment, there is provided a driver assembly wherein the damping manifold comprises a resiliently deformable material having a Shore A hardness of 100 or less. By selecting a material having a Shore A hardness of 100 or less, the damping manifold provides improved resonance damping to the driver assembly, thereby reducing unwanted resonance and distortion, in use.

In an embodiment, there is provided a driver assembly wherein the damping manifold comprises a resiliently deformable material having a Shore A hardness of 15 or more. By selecting a material having a Shore A hardness of 15 or more, excess movement of the drivers is avoided, which could otherwise cancel some of the desired acoustic output and introduce distortion. Insufficient hardness may also cause sealing provided by the damping manifold to become degraded or fail, changing design characteristics and introducing air leak noises.

In an embodiment, there is provided a driver assembly wherein the damping manifold comprises an elastomer, and preferably a silicone rubber. Elastomers provide good resonance absorption, while also providing sufficient structural strength to retain the drivers in position. Elastomers can easily be moulded into any desired shape and have good chemical and thermal stability. Silicone rubber is an example of an elastomer with particularly beneficial properties.

In an embodiment, there is provided a driver assembly wherein the damping manifold further comprises a second port arranged on an opposite side of the damping manifold to the first port such that, in use, sound is directed out of the damping manifold through the first port in a direction substantially perpendicular to the common central driver axis, and through the second port in a direction substantially perpendicular to the common central driver axis. Providing a second port allows for sound to be emitted from the driver assembly from a second direction, which is advantageous in multiple-driver loudspeakers that are designed to emit sound in multiple directions, for example from the front and the back of the loudspeaker cabinet.

In an embodiment, there is provided a driver assembly wherein at the damping manifold is formed of two or more pieces. Being formed of two or more pieces allows for greater flexibility in the construction process.

In an embodiment, there is provided a driver assembly further comprising an acoustic absorbing member disposed within the damping manifold and the second damping manifold.

According to a second aspect of the disclosure, there is provided a multiple-driver loudspeaker comprising a plurality of driver assemblies according to the first aspect, the plurality of driver assemblies including: a first group of driver assemblies in which the midpoint of each driver assembly lies on a perimeter of a first circular plane; and a second group of driver assemblies in which the midpoint of each driver assembly lies on a perimeter of a second circular plane; wherein the first and second circular planes each extends around a common central planer axis.

This arrangement driver assemblies, with the driver assemblies being arranged on a circular plane, is advantageous as the total radiating surface can be larger than would be possible with front facing driver groups contained within the same overall diameter. Since each group of driver assemblies comprises at least four drivers (in two driver assemblies), this means that the total radiating surface can be larger than for comparative existing designs that use single (i.e., not paired) surface-facing drivers within the same overall diameter. This is also advantageous in that the overall diameter of each circular plane can be reduced while still maintaining a large radiating area. By arranging the driver assemblies in groups, the total radiating area of a group of assemblies may be larger than would be possible using a forward-facing driver of the same overall diameter as the circular plane on which the driver assemblies are arranged. This arrangement of driver groups can allow for improved dispersion of the acoustic sound, and also allow for larger drivers to be used.

A further advantage of this arrangement of driver assemblies is that the radiating surface, as seen by a central higher frequency driver, or other multi-driver higher frequency band, is much less compromised by the output from lower frequency bands, because they exit via apertures that may be of much smaller area than the summed surface area of the actual drivers that create the output. Hence, the radiating surface, as seen by each higher frequency band, may appear to be physically similar to a surface without lower frequency bands. Furthermore, high excursion of the drivers in lower frequency bands causes no physical change to the radiating surface seen by the higher frequency band driver(s).

With this arrangement of driver assemblies, the length of each voice coil in each group of driver assemblies can be added to give a total length equivalent. For example, a group comprising eight 25 mm diameter coils (in four driver assemblies) have a total length of 8×25×T=628 mm, which is the same length as a single 200 mm diameter coil, a totally impossible coil size for a single driver of equivalent diameter. The coil surface area equates to the heat dissipation (assuming other conditions are equal), so for a given power input, temperature is reduced, and power compression (which causes acoustic compression) is lowered. Compression in a driver is caused by elevated coil temperatures and the subsequent rise in coil resistance. Thus, driver assemblies used in the multiple-driver loudspeakers, according to the present invention, will be more resistant to both thermal compression and thermal failure since operating temperatures will be lower for the same acoustic output.

Using multiple driver assemblies within a given frequency band and with each driver assembly contained within an individual enclosure, may be advantageous. If, for example, all internal dimensions of the enclosure are much smaller than the shortest wavelength it's required to produce, there will be no internal reflections and no standing waves.

In an embodiment, there is provided multiple-driver loudspeaker wherein the first and second circular planes are co-planar. This is advantageous as it allows for driver assemblies from separate groups to be arranged more closely. This is also advantageous as it allows for the driver assemblies to be arranged such that the virtual acoustic centre of all of the driver assemblies in each respective group is as close as possible to a single central point, thereby allowing for the best summation of acoustic sound output in all directions around the loudspeaker.

In an embodiment, there is provided multiple-driver loudspeaker wherein the first and second circular planes have different diameters. This is advantageous as it may allow for the driver assemblies of each respective group to be arranged more closely together, for example by interleaving driver assemblies from different circular planes. This may improve the use of available space within the loudspeaker. This may also be advantageous in allowing for the driver assemblies to be arranged in order to optimise the summation of acoustic sound output in all directions around the loudspeaker due to the effective diameter of each radiating group being small relative to its radiating area.

In an embodiment, there is provided multiple-driver loudspeaker wherein the diameter of the first circular plane is smaller than the diameter of the second circular plane. This is advantageous as it may allow for the driver assemblies of each respective group to be arranged more closely together, for example by interleaving driver assemblies from different circular planes.

In an embodiment, there is provided multiple-driver loudspeaker wherein for each respective circular plane, those driver assemblies lying on a perimeter of the circular plane are equally spaced from one another around the circular plane. This is advantageous as it improves the uniformity of the acoustic sound produced by the driver assemblies. Such an arrangement is also the most efficient way to interleave the drivers so allowing the smallest diameter groups. However, if the cabinet design has an un-equal aspect ratio such as one with a rectangular front face, it may in certain circumstances, be physically advantageous to space the driver groups on the cabinet diagonals, so they will be at equal distance from the centre, but not exactly evenly spaced from one another.

In an embodiment, there is provided multiple-driver loudspeaker wherein the drivers of the first group of driver assemblies are smaller than the drivers of the second group of driver assemblies. This is advantageous as it may improve the spatial efficiency with which the driver assemblies may be arranged within the loudspeaker.

In an embodiment, there is provided multiple-driver loudspeaker wherein, in use, the first group of driver assemblies are configured to produce frequencies in a first frequency band, and the second group of driver assemblies are configured to produce frequencies in a second frequency band that is at least partially non-overlapping with the first frequency band. This is advantageous as it allows for different groups of driver assemblies to be optimised to produce acoustic sound in different frequency ranges. By limiting the required range of acoustic sound frequencies that a driver assembly is required to produce, each driver or driver assembly can be optimised to produce that range of frequencies more efficiently. This is also advantageous as drivers that are optimised for producing a narrow range of frequencies are typically less expensive, smaller, and less complex than drivers that are able to produce a wider range of frequencies. Furthermore, drivers are typically more energy efficient when operating in their optimal frequency range.

According to a third aspect of the disclosure, there is provided a multiple-driver loudspeaker comprising three or more driver assemblies according to the first aspect, each driver assembly including a pair of drivers arranged on a common central driver axis bisected by a driver midpoint lying between the drivers, the midpoint of each of the three or more driver assemblies lying on a perimeter of a single circular plane.

This arrangement of driver assemblies arranged on a circular plane is advantageous as the total radiating surface can be larger than would be possible with front facing driver groups contained within the same overall group diameter. Since each group of driver assemblies comprises at least six drivers, this means that the total radiating surface is larger than for comparative existing designs that use single surface-facing drivers (or even groups of surface-facing drivers). This is also advantageous in that the overall diameter of each circular plane can be reduced while still maintaining a large radiating area. By arranging the driver assemblies around a circular plane, the total radiating area of a group of assemblies may be considerably larger than would be possible using a forward-facing driver (or group of forward-facing drivers) of the same overall diameter as the circular plane on which the driver assemblies are arranged. Furthermore, this arrangement of driver groups can allow for improved dispersion of the acoustic sound by virtue of its smaller diameter and also allow for larger drivers to be used. As discussed in relation to the second aspect, this arrangement also offers advantages in relation to thermal performance and energy efficiency.

In an embodiment, there is provided multiple-driver loudspeaker further comprising at least one driver arranged with a driver central axis shared with the common central planar axis of at least one circular plane. This is advantageous because positioning a driver in this location would allow for that driver to produce acoustic sound with the same source location as the average locations of the driver assemblies located on the one or more circular planes. This may allow, for example, for one or more high frequency drivers to provide high frequency acoustic sound with minimal interaction with the surrounding driver assemblies.

In an embodiment, there is provided multiple-driver loudspeaker wherein for each respective circular plane, those driver assemblies lying on a perimeter of the circular plane include drivers of equal size. This is advantageous as driver size may be optimised for the frequency range they reproduce while maximising force cancelling as each driver in each pair has identical moving mass to its opposite.

In an embodiment, there is provided multiple-driver loudspeaker further comprising a first baffle disposed on a first side of the plurality of driver assemblies, the first baffle comprising a plurality of openings, each opening being arranged adjacent to a respective first port. This is advantageous as the baffle prevents interference between the acoustic sound produced by the separate driver assemblies. The openings are advantageous as they allow for the acoustic sound exiting the respective first ports of the driver assemblies to escape from the loudspeaker through the baffle in particular locations, thereby minimising the interference between acoustic sound produced by different driver assemblies. The openings are further advantageous as they can be placed more closely together than would be possible for typical forward-facing drivers, thereby allowing for closer tessellation between the sound output locations (i.e., openings) for the different driver assemblies.

In an embodiment, there is provided multiple-driver loudspeaker wherein the first baffle further comprises one or more shaped portions. This is advantageous as the baffle can be shaped to optimise the overall dispersion pattern. A shallow concave baffle can help match the directivity between frequency bands at upper crossover frequencies while also slightly widening the dispersion at the highest frequencies, other shapes may have other benefits. This is particularly advantageous when compared to forward facing drivers (or driver groups) in loudspeaker designs that typically have, or require flat baffles with the driver(s) diaphragm(s) being shaped to optimise that drivers output, without reference to the needs of other drivers sharing the same baffle.

In an embodiment, there is provided multiple-driver loudspeaker further comprising one or more low-frequency driver assemblies, each low-frequency driver assembly including a pair of low-frequency drivers arranged on a common central driver axis, and wherein each of the respective low-frequency driver assemblies is arranged such that the common central driver axis of the low-frequency driver assembly is shared with the common central planar axis of at least one circular plane. These are advantageous as they increase the low frequency (LF) capability of the loudspeaker system. Furthermore, the additional LF drivers remain in a coaxial arrangement with all other drivers.

In an embodiment, there is provided multiple-driver loudspeaker including at least one circular plane having a central planar axis, further comprising two or more low-frequency drivers, each low frequency driver having a driver central axis extending perpendicular to the central planar axis of the at least one circular plane, and arranged such that the low frequency drivers are equally spaced from one another. These are advantageous as they increase the low frequency (LF) capability of the loudspeaker system. Furthermore, the additional LF drivers remain in a coaxial arrangement with all other drivers.

### BRIEF DESCRIPTION OF THE DRAWINGS

Examples of the present invention will now be described in detail with reference to the accompanying drawings, in which:

FIG. 1 illustrates a driver according to the present disclosure.

FIG. 2 illustrates a pair of matched drivers arranged facing each other on a common central driver axis bisected by a driver midpoint lying between the two drivers.

FIG. 3 illustrates a driver assembly according to the present disclosure.

FIG. 4 illustrates a damping manifold with first and second driver mounting slots according to the present disclosure.

FIG. 5 illustrates a damping manifold and driver assembly disposed within a housing, according to the present disclosure.

FIG. 6 illustrates a damping manifold and driver assembly disposed within a housing, the damping manifold divided into two parts, according to the present disclosure.

FIG. 7 illustrates a damping manifold with first and second driver mounting slots, further comprising added acoustic absorption according to the present disclosure.

FIG. 8 illustrates an example of a multiple-driver loudspeaker comprising four driver assemblies according to the present disclosure.

FIGS. 9 to 14 illustrate various examples of driver assembly orientations and combinations in multiple-driver loudspeakers according to the present disclosure.

FIG. 15 illustrates an exploded view of a multiple-driver loudspeaker comprising eight driver assemblies according to the present disclosure.

### DETAILED DESCRIPTION

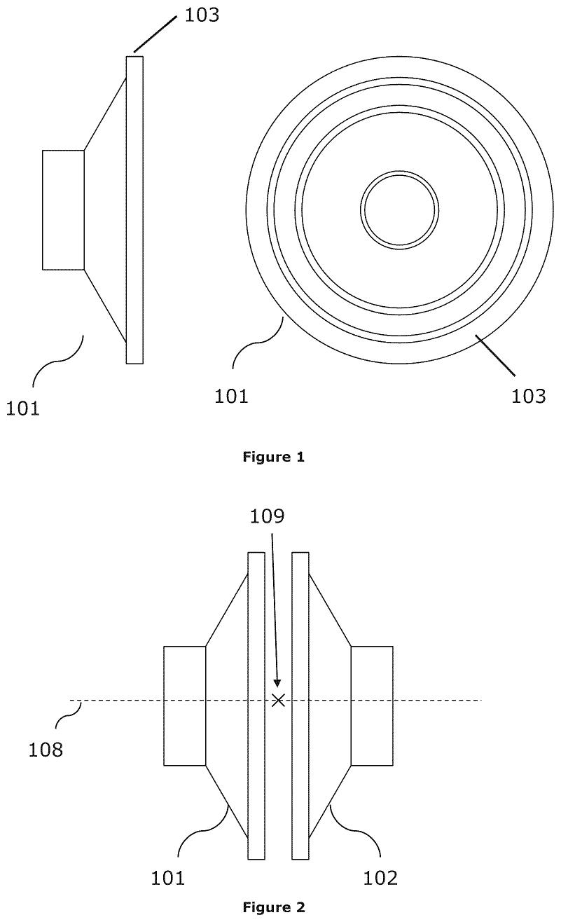

FIG. 1 illustrates an example of a driver 101 suitable for use in the driver assemblies according the present disclosure. The radiating surface of the driver 101 may be of any shape, in the illustrated example circular surfaces are used as examples. The radiating surface of the driver 101 may be flat or, as is more usual, have depth. The drivers 101 may use any type of motor systems. In some examples, moving coil motors may be used. The driver 101 comprises a flange 103 that may be used to mount the driver to a driver assembly.

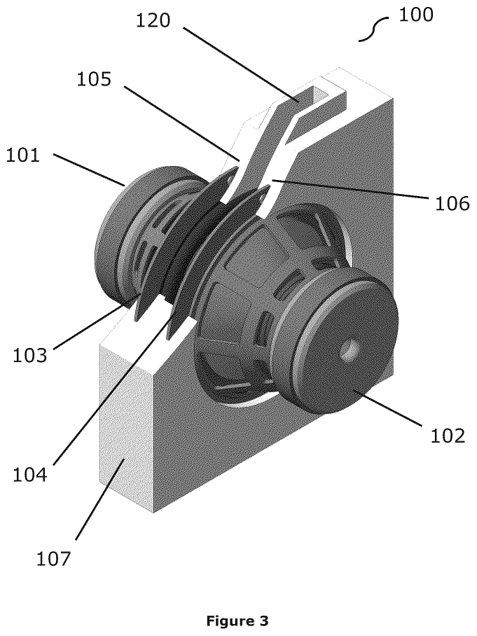

FIG. 2 illustrates a first driver 101 and a second driver 102 arranged facing one another, as is the case in driver assemblies according to the present disclosure. The first driver 101 and second driver 102 are arranged on a common central driver axis 108 bisected by a midpoint 109 lying between the first driver 101 and the second driver 102.

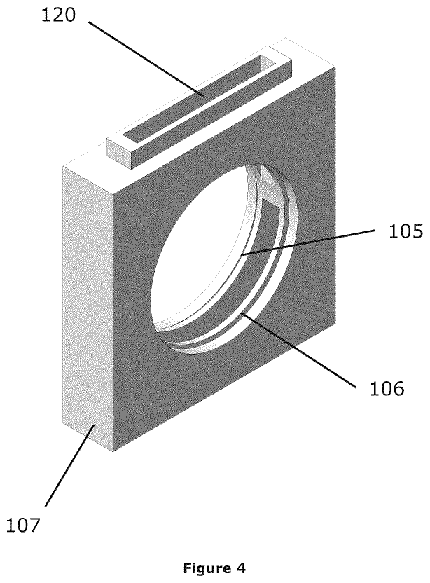

FIG. 3 illustrates an example of a driver assembly 100 according to the present disclosure. In the illustrated example, a first driver 101 comprises a first flange 103, and a second driver 102 comprises a second flange 104. The first flange 103 is received in a first driver mounting slot 105, and the second flange 104 is received in a second driver mounting slot 106. In the illustrated example, the damping manifold 107 is cut away in order to more clearly show how the flanges may be received within the respective driver mounting slots. However, it will be appreciated that this is merely for illustrative purposes. In a working example, the manifold 107 will not be cut away in this manner, an example of a non-cutaway illustration of this is shown in FIG. 4.

In the example illustrated in FIGS. 3 and 4, the damping manifold 107 is shown as being formed as a single continuous component. In some examples, this may be the arrangement used. In other examples, the damping manifold may be made from separate components.

The damping manifold 107 comprises a resiliently deformable material that is selected provide the desired resonance damping and sealing characteristics for a given driver assembly. The material may be selected so as to provide adequate structural support to the drivers, while also providing the required level of resonance damping.

A material that is too stiff may provide insufficient resonance damping and poor sealing, causing resonances and sound distortions to be produced during use of the driver assembly. In some examples, a material with a Shore A hardness of no more than 100 may provide sufficient resonance damping and sealing.

A material with insufficient stiffness may allow excess movement of the driver baskets cancelling some of the desired acoustic output and introducing distortion. It may cause the sealing provided by the damping manifold to be degraded or fail, changing design characteristics and introducing air leak noises. In some examples, a material with a Shore A hardness of at least 15 may avoid these issues.

It will be appreciated that the material requirements for a given damping manifold may depend on the properties of the drivers being mounted in said damping manifold. For example, the driver weight will necessitate sufficient physical support. Similarly, the frequency of operation of the driver may also affect the required stiffness needed to provide sufficient resonance damping.

The damping manifold may comprise any suitable material. In some examples, the damping manifold 107 may be one material and be formed as a single component. In other examples, the damping manifold may comprise separate parts and might use different materials.

In some examples, the damping manifold may be formed from silicone rubber. Silicone rubber can be moulded into a desired shape and has mechanical and physical properties (including strength and stiffness) that can be tailored to the particular requirements of any given driver assembly. Silicone rubber is chemically and thermally stable. In other examples, alternative materials may be used such as any of a wide range of suitable elastomers.

In the illustrated examples, a first port 120 is shown. The first port 120 is arranged such that, in use, sound produced by the first and second drivers is directed out of the driver assembly 100 through the first port 120 in a direction substantially perpendicular to the common central driver axis 108 (not shown). In some examples, one or more additional ports may be included (not shown) in order to direct sound out of the driver assembly in other directions substantially perpendicular to the central driver axis.

In some examples, a second port (not shown) may be included, for example arranged on the opposite side of the driver assembly 100 to the first port 120. In such examples, this may allow for a loudspeaker constructed using such driver assemblies to direct sound out of a front face and a rear face of the loudspeaker cabinet.

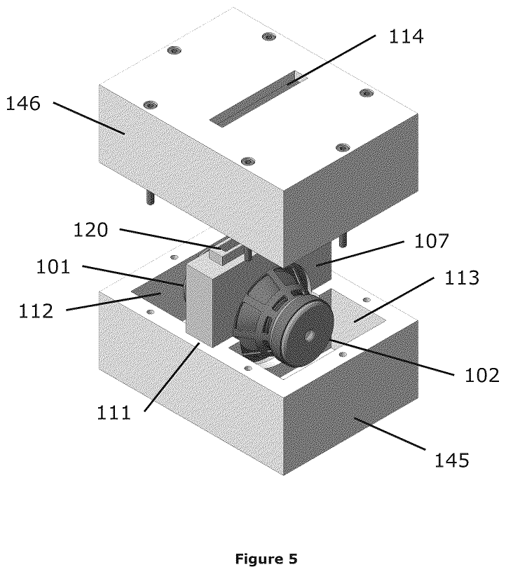

FIG. 5 illustrates a driver assembly further comprising a housing 110. The housing comprises a first back chamber 112, a second back chamber 113 and a central chamber 111. The first back chamber accommodates the back of the first driver 101. The second back chamber accommodates the back of the second driver 102. The central chamber 111 accommodates the front of the first and second drivers, and the damping manifold 107.

In the illustrated example, the housing is separated into two halves. This illustrates an example of how a driver assembly 100 according to the present disclosure may be constructed. In the illustrated example, the flanges of the first and second drivers have been inserted into the respective driver mounting slots, and then inserted into the lower half of the housing. The upper half of the housing may then be attached to the lower half of the housing in order to form the driver assembly 100. The upper half of the housing 110 comprises an opening 114 through which the first port 120 extends.

When the top half 146 and bottom half 145 of the housing 110 are joined together, the damping manifold 107, seals the first back chamber 112 from the central chamber 111, and the second back chamber 113 from the central chamber 111. Sealing the back chambers from the central manifold chamber allows for the drivers to produce sound to be emitted through the first slot 120, without sound leaking from the back chambers.

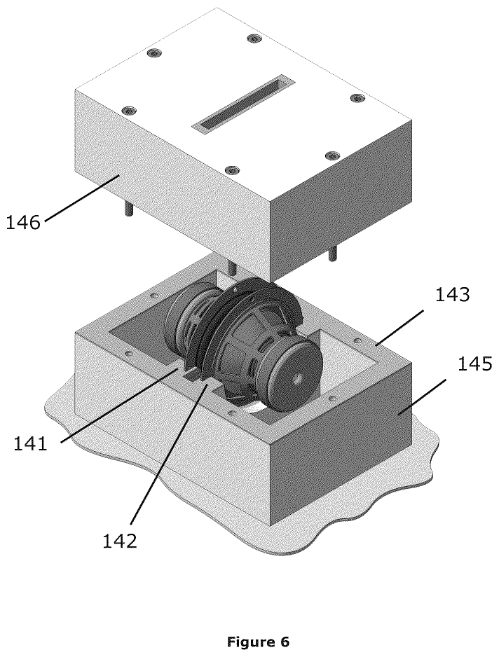

FIG. 6 illustrates an alternative arrangement of the housing 110 and damping manifold 107. In the illustrated example, the damping manifold 107 is separated into two pieces, with a piece of each disposed in each half of the housing 110. The housing 110 further comprises a gasket 143 arranged between the two halves of the housing 110. In the illustrated example, the gasket 143 is moulded continuously with the lower part of the damping manifold, although in other examples these may be separate components. In some examples, a second gasket might be included on the top housing 110, and may be formed as part of the upper portion of the damping manifold. When the upper portion 146 and lower portion 145 of the housing 110 are brought together, the two halves of the damping manifold are brought together. Each half of the damping manifold thereby retains the respective flanges of the respective drivers within their driver mounting slots, and seals the respective back chamber of the housing from the central chamber. When assembled, the driver assembly 100 illustrated in FIG. 6 will, in use, perform substantially the same as the one illustrated in FIG. 5.

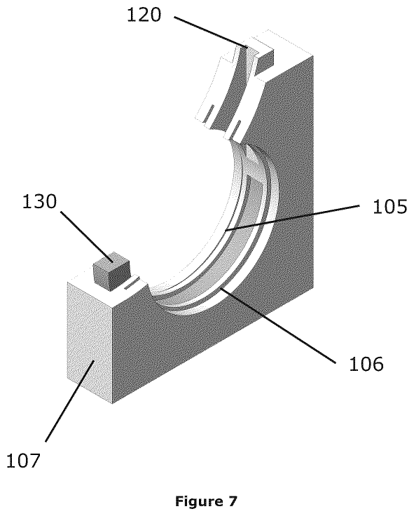

FIG. 7 illustrates an example of a first and second damping manifolds further comprising an acoustic absorbing member 130. The space between the first damping manifold 105 and the second damping manifold 106 is where the desired sound is produced by the first driver 101 and the second driver 102, in use. This space will exhibit internal reflections and resonances that will depend on the dimensions of the space, the width, depth and cone depth of the drivers, and the distance to the top of the first port 120. The skilled person will appreciate that these properties may be selected in order to keep the onset of these issues above the required frequency range of the driver assembly. However, if the desired upper working frequency is approaching the problem frequencies, additional absorption in the form of one or more absorption members 130 may be fitted in order to modify the reflections and/or resonances associated with the space. The material, density, thickness and placement of the absorbing member 130 may be carefully selected in order to modify the properties of the space accordingly. With well-chosen characteristics for the absorbing member, 10-12 dB of modification may be possible. Creating a ‘Meta Absorber’ with its entry port(s) within the manifold is an alternative method of acoustic absorption.

Driver assemblies according to the present disclosure may be used in a multiple-driver loudspeaker. Examples of such a loudspeaker will now be discussed with reference to the illustrated examples shown in the figures.

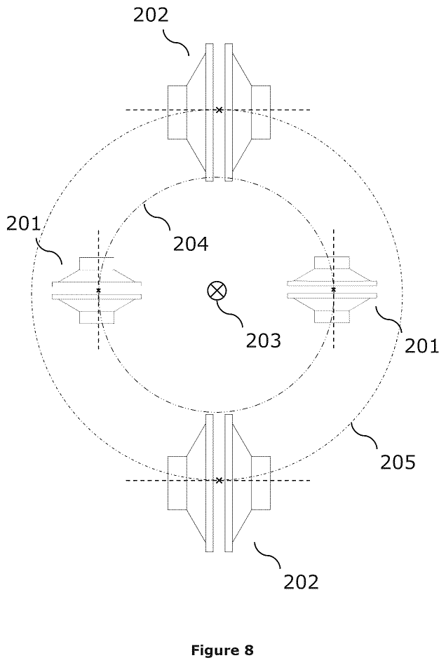

FIG. 8 illustrates an arrangement of driver assemblies in a multiple-driver loudspeaker according to the present disclosure. The driver assemblies shown in FIG. 8 are illustrated showing only the drivers, their respective common central planar axes and their driver midpoints. This is purely for simplicity, in a real example of a multiple-driver loudspeaker according to the present disclosure the driver assemblies will include all of the required features outlined above.

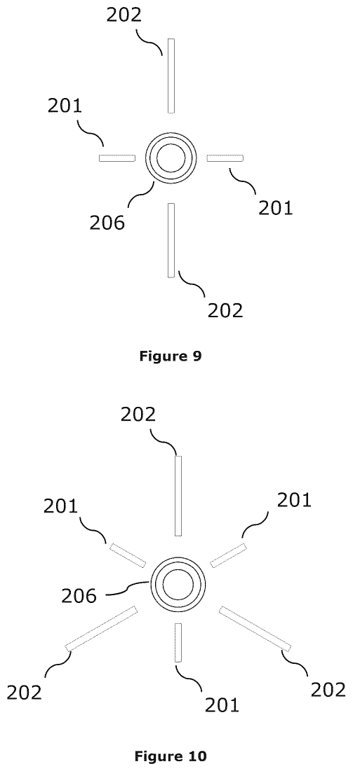

In the illustrated example, a first group of driver assemblies 201 arranged with the midpoint of each driver assembly 201 arranged on a perimeter of a first circular plane 205. In the illustrated example, the first group of driver assemblies 201 includes two driver assemblies 201. However, in some examples, more than two driver assemblies may be included in the first group. In some examples, as illustrated in FIG. 9 onwards, the first group may include three or four driver assemblies, for example.

A second group of driver assemblies 202 are arranged with the midpoint of each driver assembly 202 arranged on a perimeter of a second circular plane 205. In the illustrated example, the second group of driver assemblies 202 includes two driver assemblies 202. However, in some examples, more than two driver assemblies may be included in the second group. In some examples, as illustrated in FIG. 9 onwards, the second group may include three or four driver assemblies, for example.

In the illustrated example, the first driver assemblies 201 comprise smaller drivers than the second driver assemblies 202. In the illustrated example, the first driver assemblies 201 are therefore configured to operate in a higher frequency band than the second driver assemblies 202. The combination of the driver assemblies 201 and 202 thus allow for a wider range of frequencies to be produced.

The first group and second group of driver assemblies arranged such that the first circular plane 204 and the second circular plane 205 each extends around a common central planar axis 203. In the illustrated example, the first group of driver assemblies and the second group of driver assemblies are arranged such that the four illustrated driver assemblies 201, 202 are evenly spaced around the common central planar axis 203 with respect to each other. However, in some examples, the driver assemblies of different groups may be aligned with one another or may be arranged with non-equal separations.

In some examples, more than two groups of driver assemblies may be included in the multiple-driver loudspeaker. In such examples, further groups of driver assemblies may be arranged with the mid-point of each driver assembly on a perimeter of further circular planes, each arranged around the common central planar axis 203. In some examples, these additional circular planes may have different diameters. In some examples, these additional circular planes may have the same diameters as one or more other circular planes. In some examples, these other groups may comprise driver assemblies with sizes other than those of the first two groups. In further examples, driver groups may contain more than one driver pair of the same or different sizes, with all pairs sharing a common exit port and common back chambers. Pairs may be driven with identical inputs or with different inputs. Different inputs would usually use shared low frequency high pass filters but have different high frequency low pass filters, the furthest pairs from the centre usually with lower frequency low pass filters.

FIGS. 9 to 14 illustrate various examples of arrangements of driver assemblies according to the present disclosure. Other arrangements are also envisaged, the figures merely provide some illustrated examples of arrangement within the limitations of the present disclosure. For simplicity, in FIGS. 9 to 13 the driver assemblies are represented by slots. Each slot represents a first port 120 of a respective driver assembly.

FIG. 9 illustrates a “two-fold” arrangement. Two first driver assemblies 201 and two second driver assemblies 202 are arranged around a common central planar axis (not shown). The driver assemblies are arranged such that they are evenly spaced around the common central planar axis, and such that the first driver assemblies 201 and second driver assemblies 202 alternate around the common central planar axis. Such an arrangement has two-fold rotational symmetry around the central planar axis. In the illustrated example, a further central driver 206 is arranged with its driver central axis shared with the common central planar axis of the other driver assemblies, meaning that it is facing outwards from the planes of the other driver assemblies. The central driver 206 will typically be a single high-frequency driver, often referred to as a “tweeter”. In some examples (not shown) the central driver 206 may not be present.

FIG. 10 illustrates a “three-fold” arrangement. Three first driver assemblies 201 and three second driver assemblies 202 are arranged around a common central planar axis (not shown). The driver assemblies are arranged such that they are evenly spaced around the common central planar axis, and such that the first driver assemblies 201 and second driver assemblies 202 alternate around the common central planar axis. Such an arrangement has three-fold rotational symmetry around the central planar axis. A central driver 206 is arranged with its driver central axis shared with the common central planar axis of the other driver assemblies, meaning that it is facing outwards from the planes of the other driver assemblies.

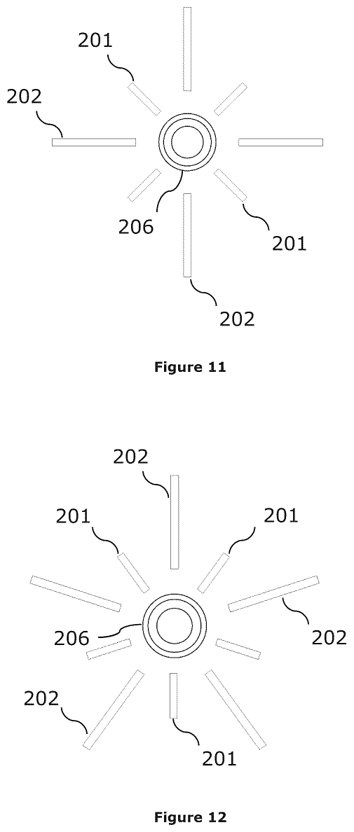

FIG. 11 illustrates a “four-fold” arrangement. Four first driver assemblies 201 and four second driver assemblies 202 are arranged around a common central planar axis (not shown). The driver assemblies are arranged such that they are evenly spaced around the common central planar axis, and such that the first driver assemblies 201 and second driver assemblies 202 alternate around the common central planar axis. Such an arrangement has four-fold rotational symmetry around the central planar axis. A central driver 206 is arranged with its driver central axis shared with the common central planar axis of the other driver assemblies, meaning that it is facing outwards from the planes of the other driver assemblies.

FIG. 12 illustrates a “five-fold” arrangement. Five first driver assemblies 201 and five second driver assemblies 202 are arranged around a common central planar axis (not shown). The driver assemblies are arranged such that they are evenly spaced around the common central planar axis, and such that the first driver assemblies 201 and second driver assemblies 202 alternate around the common central planar axis. Such an arrangement has five-fold rotational symmetry around the central planar axis. A central driver 206 is arranged with its driver central axis shared with the common central planar axis of the other driver assemblies, meaning that it is facing outwards from the planes of the other driver assemblies.

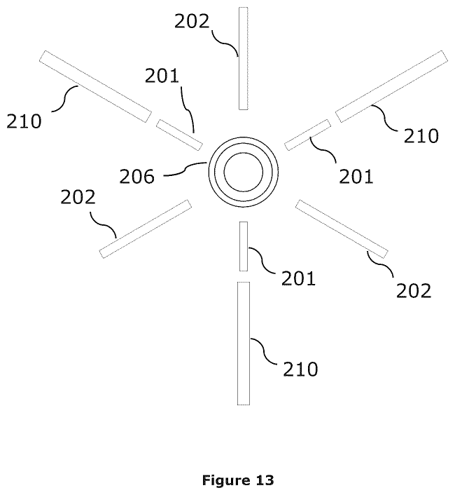

FIG. 13 illustrates a “three-fold, four-way” arrangement. Three first driver assemblies 201 and three second driver assemblies 202 are arranged around a common central planar axis (not shown). Three third driver assemblies 210 are arranged around the common central planar axis on a third circular plane with a central planar axis common with the central planar axes of the first and second circular planes (no circular planes are shown in the illustration). In the illustrated example, each of the third driver assemblies 210 is arranged adjacent to a first driver assembly 201. Such an arrangement may be beneficial, for example, in maximising spatial efficiency within the driver cabinet. The driver assemblies are arranged such that they are evenly spaced around the common central planar axis, and such that the first driver assemblies 201 and second driver assemblies 202 alternate around the common central planar axis. Such an arrangement has three-fold rotational symmetry around the central planar axis. A central driver 206 is arranged with its driver central axis shared with the common central planar axis of the other driver assemblies, meaning that it is facing outwards from the planes of the other driver assemblies. Each of the groups of driver assemblies in the illustrated example comprise a different size of drivers in their respective driver assemblies. In the illustrated example the central driver 206 is a different size to any used in the three respective driver groups, meaning that there are four different sizes of drivers used. The illustrated multiple-driver loudspeaker may therefore be referred to as a “four-way” loudspeaker.

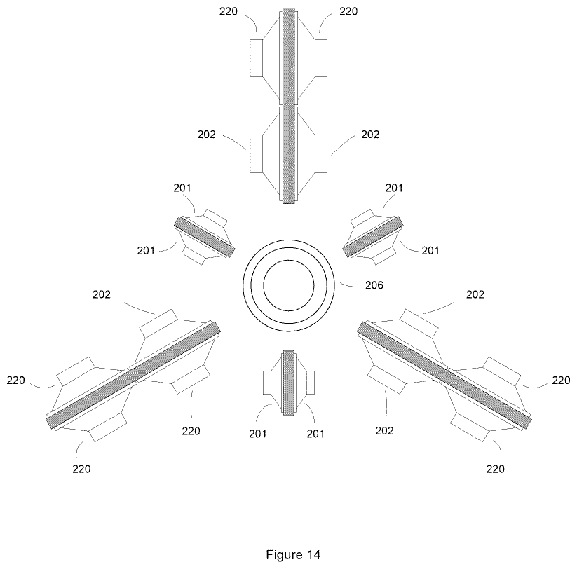

FIG. 14 illustrates a “three-fold, three and a half way” arrangement. Three first driver assemblies 201 and three second driver assemblies 202 are arranged around a common central planar axis (not shown). A further arrangement of second driver assemblies 220 share the same manifolds and back chamber as the second driver assemblies 202. This group may use the same drivers as in assemblies 202 or drivers of similar size. The effect is similar to using high aspect ratio drivers (commonly called ‘race track’ drivers) but with the advantage of being able to drive assemblies 220 with a low pass filtered version of the feed to assemblies 202 thereby keeping the higher frequency output within a small area but retaining the lower frequency capability. Such an arrangement with two or more drivers sharing sections of a frequency band is commonly called a ‘half’ way.

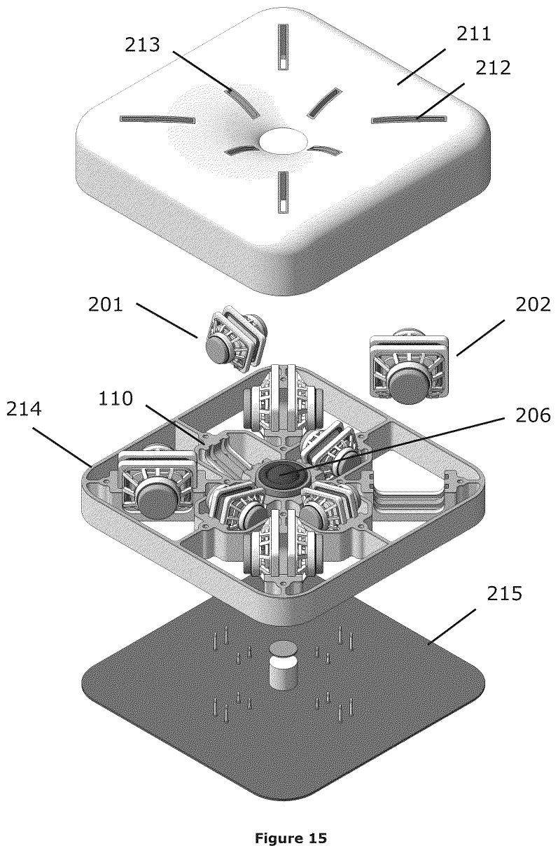

FIG. 15 illustrates an exploded view of a multiple-driver loudspeaker according to the present disclosure. The multiple-driver loudspeaker comprises a first group of four driver assemblies 201 arranged with their respective midpoints on a perimeter of a first circular plane (not shown), and a second group of four driver assemblies 202 arranged with their respective midpoints on a perimeter of a second circular plane (not shown) that is larger than the first circular plane. Each of the respective circular planes are arranged around the common central planar axis (not shown).

The multiple-driver loudspeaker further comprises a central driver 206 arranged with its driver central axis shared with the common central planar axis of the other driver assemblies. The first driver assemblies 201 comprise smaller drivers than the second driver assemblies 202, and are therefore configured to operate in a higher frequency band than the second driver assemblies 202. The combination of the driver assemblies 201 and 202, and the smaller central driver 206, thus allow for a wide range of frequencies to be produced.

Each of the driver assemblies have a respective housing 110. In the illustrated example, each of the housings 110 are connected to, or integral with, a frame 214. In some examples, the base of the assembly 215 may comprise a Printed Circuit Board (PCB) to which one or more of the drivers may be electrically connected. In such examples, the PCB would then facilitate electrical interconnection between each of the electrically connected drivers, thereby reducing wiring complexity of the loudspeaker.

In some examples, one or more of the individual drivers may comprise spring contacts and/or pads for corresponding PCB mounted sprung contacts to mate with. Such an arrangement may significantly reduce the complexity of assembling the multiple-driver loudspeaker, and may facilitate partially, or even fully, automated assembly of the multiple driver loudspeaker. Using multi-material moulding techniques to form all or some of the housings 110 integrally with the frame 214 allows a single manufactured component to form the hard frame, the damping manifold halves and a complete gasket to seal the assembly. The PCB may be permanently bonded to the lower frame 214 forming a seal to each back chamber The multiple-driver loudspeaker illustrated in FIG. 15 further comprises a baffle 211. The baffle includes a slot arranged adjacent to each of the driver assemblies, through which sound produced by the respective driver assemblies may be emitted from the loudspeaker. In the illustrated example, the size of the slots corresponds to the size of the adjacent driver assembly, with larger slots 212 adjacent to the larger driver assemblies 202, and smaller slots adjacent to the smaller driver assemblies 201.

The baffle 211 has a shallow concave shape, curving inwards towards the central driver 206. Such a design can help match the directivity between frequency bands at upper crossover frequencies while also slightly widening the dispersion at the highest frequencies. This is particularly advantageous when compared to traditional loudspeaker designs that typically use flat baffles. Other examples are envisaged, where the shape of the baffle 211 may be adjusted in any suitable way to optimise the acoustic sound output of the multiple-driver loudspeaker.

Although the above description refers primarily to the use of driver assemblies in multiple-driver loudspeakers, it should be understood that other usages are envisaged. The above-described examples are to be considered merely possible uses of the present disclosure, and should not be considered limiting to the scope of the invention. Driver sizes may be chosen such that an assembly might form part of or all of a sound channel in such applications as laptop computers, television sound bars and portable ‘Bluetooth’ loudspeakers. Alternatively, driver sizes might be chosen to form high power, high performance loudspeakers such as those used in recording studios. Size of drivers and quantity of driver assemblies may be optimised for each use. The aim of all such assemblies is to form multiway coaxial loudspeakers with higher capability than might be available from conventional loudspeakers of similar size, little or no interaction between sections (or ‘ways’) and perfect or near perfect time alignment between the acoustical centre of each section (or ‘way’).

1. A driver assembly for use in a multiple-driver loudspeaker for converting electrical signals into acoustic sound, the driver assembly comprising:
a first driver having a first flange;
a second driver having a second flange; and
a damping manifold having a first mounting slot arranged to retain the first flange, and a second mounting slot arranged to retain the second flange, and a first port;
wherein when the first and second flanges are received into the respective mounting slots, the first and second drivers are arranged facing each other on a common central driver axis bisected by a driver midpoint lying between the first and second drivers;
wherein the first port is arranged such that, in use, sound is directed out of the damping manifold through the first port in a direction substantially perpendicular to the common central driver axis; and
wherein the damping manifold comprises a resiliently deformable material selected to provide resonance damping, in use.

2. The driver assembly according to claim 1 further comprising a housing having a first back chamber, a second back chamber, and a central chamber disposed between the first and second back chambers, the central chamber being configured to receive and retain the damping manifold.

3. The driver assembly according to claim 2, wherein the damping manifold is arranged to provide a seal between the first back chamber and the central chamber, and a seal between the second back chamber and the central chamber.

4. The driver assembly according to claim 1, wherein the damping manifold comprises a resiliently deformable material having a Shore A hardness of 100 or less.

5. The driver assembly according to claim 1, wherein the damping manifold comprises a resiliently deformable material having a Shore A hardness of 15 or more.

6. The driver assembly according to claim 1, wherein the damping manifold comprises an elastomer.

7. The driver assembly according to claim 1, wherein the damping manifold further comprises a second port arranged on an opposite side of the damping manifold to the first port such that, in use, sound is directed out of the damping manifold through the first port in a direction substantially perpendicular to the common central driver axis, and through the second port in a direction substantially perpendicular to the common central driver axis.

8. The driver assembly according to claim 1, wherein at the damping manifold is formed of two or more pieces.

9. The driver assembly according to claim 1, further comprising an acoustic absorbing member disposed within the damping manifold.

10. The multiple-driver loudspeaker comprising a plurality of driver assemblies according to claim 1, the plurality of driver assemblies including:
a first group of driver assemblies in which the midpoint of each driver assembly lies on a perimeter of a first circular plane; and
a second group of driver assemblies in which the midpoint of each driver assembly lies on a perimeter of a second circular plane;
wherein the first and second circular planes each extends around a common central planar axis.

11. The multiple-driver loudspeaker according to claim 10, wherein the first and second circular planes are co-planar.

12. The multiple-driver loudspeaker according to claim 10, wherein the first and second circular planes have different diameters.

13. The multiple-driver loudspeaker according to claim 10, wherein the diameter of the first circular plane is smaller than the diameter of the second circular plane.

14. The multiple-driver loudspeaker according to claim 10, wherein for each respective circular plane, those driver assemblies lying on a perimeter of the circular plane are equally spaced from one another around the circular plane.

15. The multiple-driver loudspeaker according to claim 10, wherein the drivers of the first group of driver assemblies are smaller than the drivers of the second group of driver assemblies.

16. The multiple-driver loudspeaker according to claim 10, wherein, in use, the first group of driver assemblies are configured to produce frequencies in a first frequency band, and the second group of driver assemblies are configured to produce frequencies in a second frequency band that is at least partially non-overlapping with the first frequency band.

17. The multiple-driver loudspeaker comprising three or more driver assemblies according to claim 1, each driver assembly including a pair of drivers arranged on a common central driver axis bisected by a driver midpoint lying between the drivers, the midpoint of each of the three or more driver assemblies lying on a perimeter of a single circular plane.

18. The multiple-driver loudspeaker according to claim 10, further comprising at least one driver arranged with a driver central axis shared with the common central planar axis of at least one circular plane.

19. The multiple-driver loudspeaker according to claim 10, wherein for each respective circular plane, those driver assemblies lying on a perimeter of the respective circular plane include drivers of equal size.

20. The multiple-driver loudspeaker according to claim 10, further comprising a first baffle disposed on a first side of the plurality of driver assemblies, the first baffle comprising a plurality of openings, each opening being arranged adjacent to a respective first port.

21. The multiple-driver loudspeaker according to claim 20, wherein the first baffle further comprises one or more shaped portions.

22. The multiple-driver loudspeaker according to claim 17, further comprising one or more low-frequency driver assemblies, each low-frequency driver assembly including a pair of low-frequency drivers arranged on the common central driver axis, and wherein each of the respective low-frequency driver assemblies is arranged such that the common central driver axis of the low-frequency driver assembly is shared with the common central planar axis of the circular plane.

23. The multiple-driver loudspeaker according to claim 17, further comprising two or more low-frequency drivers, each low frequency driver having a driver central axis extending perpendicular to the central planar axis of the circular plane, and arranged such that the low frequency drivers are equally spaced from one another.
